(19) United States
(12) Patent Application Publication
(10) Pub. No.: US 2026/0249727 A1
(43) Pub. Date: Aug. 27, 2026

(54) CHARGING DEVICE AND METHOD THEREOF

(71) Applicant: LITE-ON TECHNOLOGY CORPORATION, Taipei (TW)

(72) Inventors: Chien-Hao HUNG, Taipei (TW); Kang-Wei LIU, Taipei (TW)

(21) Appl. No.: 19/172,701

(22) Filed: Apr. 8, 2025

(30) Foreign Application Priority Data
Feb. 27, 2025 (CN) 202510227615.6

(51) Int. Cl. B60L 53/62; B60L 53/18; B60L 53/20; B60L 53/30; B60L 53/66; H02J 7/02

(52) U.S. Cl. CPC B60L 53/62; B60L 53/18; B60L 53/20; B60L 53/30; B60L 53/66; H02J 7/02; B60L 2210/10; B60L 2210/30

(57) ABSTRACT

The present invention discloses a charging device and method. The charging method includes: converting the AC voltage by a power supply cabinet to obtain a power supply cabinet output voltage; supplying a terminal input voltage from the power supply cabinet to a terminal gun cabinet through a first connection cable; detecting the terminal input voltage at the terminal gun cabinet using the terminal gun cabinet; based on a detection result, determining whether the terminal input voltage at the terminal gun cabinet has reached a terminal target value; and based on a determination result, deciding whether to notify a control unit of the power supply cabinet to perform voltage compensation until the control unit of the terminal gun cabinet determines that the terminal input voltage at the terminal gun cabinet has reached the terminal target value.

This application claims the benefit of China application Serial No. 202510227615.6, filed on Feb. 27, 2025, the disclosure of which is incorporated by reference herein in its entirety.

### TECHNICAL FIELD

The present invention relates to a charging device and method.

### BACKGROUND

Electric vehicles (EVs) are gaining increasing attention from consumers. The advantages of EVs include: (1) Environmental Protection and Emission Reduction: EVs do not emit exhaust gases, helping to reduce air pollution. (2) Energy Diversification: Electricity can be generated from various renewable sources, such as solar and wind energy, reducing dependence on fossil fuels. (3) Noise Reduction: EVs operate with lower noise levels, contributing to reduced urban noise pollution. (4) Lower Energy Costs: Electricity prices are generally lower than fuel prices, making EV operation more cost-effective. (5) Lower Maintenance Costs: EVs lack traditional internal combustion engines, have fewer components, and require less maintenance.

However, if charging stations are insufficient, the accessibility and convenience of charging infrastructure will be limited, negatively impacting user experience. Additionally, prolonged charging times may test consumer patience.

Currently, an increasing number of consumers, when conditions allow, opt to install their own EV charging devices. An EV charging device typically consists of multiple cabinets (also referred to as enclosures), which are interconnected by wiring to transfer power. However, these connecting wires can cause voltage loss. If voltage loss from the wiring is not compensated for during charging, it can negatively affect the charging efficiency of EVs.

Therefore, this invention provides a charging device and method to improve existing EV charging limitations.

### SUMMARY

According to one embodiment, a charging device is provided. The charging device is for receiving an alternating current (AC) voltage from a power supply device and charging a vehicle. The charging device comprises: a power supply cabinet, coupled to the power supply device, for converting the AC voltage received from the power supply device to obtain a power supply cabinet output voltage; a first connection cable, coupled to the power supply cabinet; and a terminal gun cabinet, coupled to the first connection cable, wherein the terminal gun cabinet is connected to and communicates with the power supply cabinet via the first connection cable, and the power supply cabinet supplies a terminal input voltage to the terminal gun cabinet through the first connection cable. Wherein, a detection circuit of the terminal gun cabinet detects the terminal input voltage of the terminal gun cabinet; based on a detection result of the terminal gun cabinet, a control unit of the terminal gun cabinet determines whether the terminal input voltage of the terminal gun cabinet has reached a terminal target value; and based on a determination result of the terminal gun cabinet, the terminal gun cabinet decides whether to notify a control unit of the power supply cabinet to perform voltage compensation until the control unit of the terminal gun cabinet determines that the terminal input voltage of the terminal gun cabinet has reached the terminal target value.

According to another embodiment, a charging method is provided. The charging method is for receiving an alternating current (AC) voltage from a power supply device and charging a vehicle. The charging method comprises: converting the AC voltage received from the power supply device by a power supply cabinet to obtain a power supply cabinet output voltage; supplying a terminal input voltage by the power supply cabinet to a terminal gun cabinet through a first connection cable, wherein the terminal gun cabinet is connected to and communicates with the power supply cabinet via the first connection cable; detecting the terminal input voltage of the terminal gun cabinet by a detection circuit of the terminal gun cabinet; based on a detection result of the terminal gun cabinet, determining, by a control unit of the terminal gun cabinet, whether the terminal input voltage of the terminal gun cabinet has reached a terminal target value; and based on a determination result of the terminal gun cabinet, deciding whether the terminal gun cabinet should notify a control unit of the power supply cabinet to perform voltage compensation until the control unit of the terminal gun cabinet determines that the terminal input voltage of the terminal gun cabinet has reached the terminal target value.

### BRIEF DESCRIPTION OF THE DRAWINGS

FIG. 1 illustrates a functional block diagram of an electric vehicle (EV) charging device according to an embodiment of the present invention.

FIG. 2 illustrates a flowchart of an EV charging method according to an embodiment of the present invention.

FIG. 3 illustrates another embodiment of the EV charging method.

FIG. 4 shows a functional block diagram of a charging device according to another embodiment of the application.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Technical terms of the disclosure are based on general definition in the technical field of the disclosure. If the disclosure describes or explains one or some terms, definition of the terms is based on the description or explanation of the disclosure. Each of the disclosed embodiments has one or more technical features. In possible implementation, one skilled person in the art would selectively implement part or all technical features of any embodiment of the disclosure or selectively combine part or all technical features of the embodiments of the disclosure.

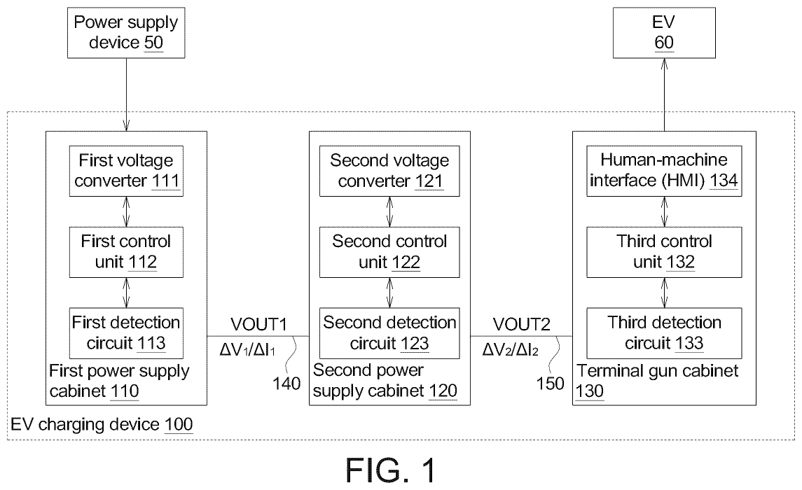

FIG. 1 illustrates a functional block diagram of an electric vehicle (EV) charging device according to an embodiment of the present invention. The EV charging device 100 receives alternating current (AC) power from a power supply device 50 and charges an EV (also referred to as a “charging target device”) 60.

The EV charging device 100 includes a first power supply cabinet 110, a second power supply cabinet 120, a terminal gun cabinet 130, and connecting cables 140 and 150. The connecting cable 140 links the first power supply cabinet 110 to the second power supply cabinet 120, while the connecting cable 150 connects the second power supply cabinet 120 to the terminal gun cabinet 130.

The first power supply cabinet 110 comprises a first voltage converter 111, a first control unit 112, and a first detection circuit 113. The first control unit 112 is coupled to both the first voltage converter 111 and the first detection circuit 113. The first control unit 112 controls the operation of the first voltage converter 111, which may be, but is not limited to, an AC/DC converter. The first voltage converter 111 converts the AC power supplied by the power supply device 50 into a first output voltage VOUT1, which is transmitted through the connecting cable 140 to the second power supply cabinet 120. The first detection circuit 113 monitors the input voltage (i.e., the AC power from the power supply device 50) and input current flowing through the first power supply cabinet 110, and transmits the detected results to the first control unit 112. The first control unit 112 communicates with the second control unit 122 via the connecting cable 140. The first control unit 112 may be, but is not limited to, a microcontroller unit (MCU).

The second power supply cabinet 120 comprises a second voltage converter 121, a second control unit 122, and a second detection circuit 123. The second control unit 122 is coupled to both the second voltage converter 121 and the second detection circuit 123, controlling the operation of the second voltage converter 121, which may be, but is not limited to, a DC/DC converter. The second voltage converter 121 converts the first output voltage VOUT1 received from the first voltage converter 111 into a second output voltage VOUT2, which is transmitted through the connecting cable 150 to the terminal gun cabinet 130. The second detection circuit 123 monitors the input voltage and input current flowing through the second power supply cabinet 120, and transmits the detected results to the second control unit 122. The second control unit 122 communicates with the first control unit 112 through the connecting cable 140 and with the third control unit 132 in the terminal gun cabinet 130 through the connecting cable 150. The second control unit 122 may be, but is not limited to, a microcontroller. Due to wire loss in the connecting cable 140, the input voltage received by the second power supply cabinet 120 is lower than the first output voltage VOUT1 from the first voltage converter 111 in the first power supply cabinet 110. Therefore, if the second detection circuit 123 detects that the input voltage received by the second power supply cabinet 120 does not meet the required target value, the second control unit 122 notifies the first control unit 112. The target value can be dynamically adjusted based on the power needs of the EV 60. In response, the first control unit 112 controls the first voltage converter 111 to increase the first output voltage VOUT1 until the input voltage received by the second power supply cabinet 120 meets the required target value. This mechanism serves as the voltage/current compensation system of the present invention.

The terminal gun cabinet 130 comprises a third control unit 132, a third detection circuit 133, and a human-machine interface (HMI) 134. The third control unit 132 is coupled to both the third detection circuit 133 and the HMI 134. The third detection circuit 133 monitors the input voltage (also referred to as the terminal input voltage) and input current (also referred to as the terminal input current) flowing through the terminal gun cabinet 130, then transmits the detected results to the third control unit 132. The third control unit 132 may be, but is not limited to, a microcontroller. Due to wire loss in the connecting cable 150, the input voltage received by the terminal gun cabinet 130 is lower than the second output voltage VOUT2 from the second voltage converter 121 in the second power supply cabinet 120. Thus, if the third detection circuit 133 detects that the input voltage received by the terminal gun cabinet 130 does not meet the required target value, the third control unit 132 notifies the second control unit 122. In response, the second control unit 122 controls the second voltage converter 121 to increase the second output voltage VOUT2 until the input voltage received by the terminal gun cabinet 130 meets the required target value. This mechanism serves as the voltage/current compensation system of the present invention. The HMI 134 provides a user interface for operation.

In FIG. 1, V₁ and I₁ represent the voltage and current detected by the first detection circuit 113 in the first power supply cabinet 110. Similarly, V₂ and I₂ represent the voltage and current detected by the second detection circuit 123 in the second power supply cabinet 120, while V₃ and I₃ represent those detected by the third detection circuit 133 in the terminal gun cabinet 130. ΔV₁ and ΔI₁ represent the voltage drop and current drop caused by the connecting cable 140, while ΔV₂ and ΔI₂ represent the voltage drop and current drop caused by the connecting cable 150.

Thus, in an embodiment of the present invention, to compensate for wire losses between the first power supply cabinet 110, second power supply cabinet 120, and terminal gun cabinet 130, detection circuits are added within the first power supply cabinet 110, second power supply cabinet 120, and terminal gun cabinet 130. The control units calculate the amount of wire loss and compensate by adjusting the output voltage accordingly, ensuring that the voltage and current at the EV charging terminal are accurate and the charging power remains stable.

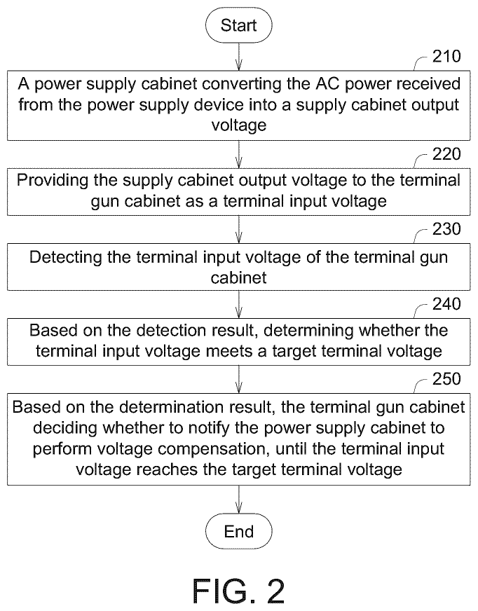

FIG. 2 illustrates a flowchart of an EV charging method according to an embodiment of the present invention. Refer to FIG. 2. In Step 210, a power supply cabinet (including the first power supply cabinet 110 and/or the second power supply cabinet 120) converts the AC power received from the power supply device into a supply cabinet output voltage. In Step 220, a first connecting cable transmits the supply cabinet output voltage to the terminal gun cabinet as a terminal input voltage. In Step 230, a detection circuit in the terminal gun cabinet detects the terminal input voltage of the terminal gun cabinet. In Step 240, based on the detection result of the terminal gun cabinet, the control unit of the terminal gun cabinet determines whether the terminal input voltage meets a target terminal voltage. In Step 250, based on the determination result of the terminal gun cabinet, the terminal gun cabinet decides whether to notify the control unit of the power supply cabinet to perform voltage compensation, until the control unit of the terminal gun cabinet determines that the terminal input voltage of the terminal gun cabinet reaches the target terminal voltage.

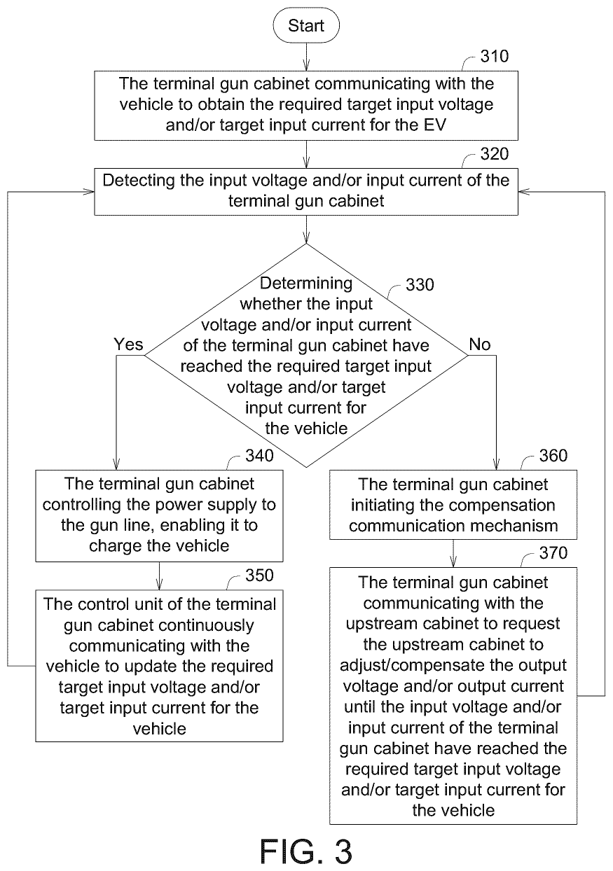

FIG. 3 illustrates another embodiment of the EV charging method. In Step 310, the control unit of the terminal gun cabinet (130 in FIG. 1) communicates with the vehicle (i.e., the EV) to obtain the required target input voltage and/or target input current for the EV. The terminal gun cabinet includes N gun lines, where N is a positive integer greater than or equal to 1.

In Step 320, the detection circuit of the terminal gun cabinet detects the input voltage and/or input current.

In Step 330, the control unit of the terminal gun cabinet determines whether the input voltage and/or input current of the terminal gun cabinet have reached the required target input voltage and/or target input current for the vehicle.

In Step 340, if the control unit of the terminal gun cabinet determines that the input voltage and/or input current of the terminal gun cabinet have reached the required target input voltage and/or target input current for the vehicle, the control unit of the terminal gun cabinet controls the power supply to the gun line, enabling it to charge the vehicle.

In Step 350, the control unit of the terminal gun cabinet continuously communicates with the vehicle to update (if necessary) the required target input voltage and/or target input current for the vehicle. This is because, as the electric vehicle continues to charge, its required target input voltage and/or target input current may change. After Step 350, the process returns to Step 320.

In Step 360, if the control unit of the terminal gun cabinet determines that the input voltage and/or input current of the terminal gun cabinet have not reached the required target input voltage and/or target input current for the vehicle, the control unit of the terminal gun cabinet initiates the compensation communication mechanism. If the terminal gun cabinet 130 includes multiple gun lines, these gun lines can individually charge respective different electric vehicles. The control unit 132 of the terminal gun cabinet 130 individually compensates and controls the output voltage and output current of each gun line based on the specific needs of each vehicle.

In Step 370, the control unit of the terminal gun cabinet communicates with the upstream control unit of the upstream cabinet (e.g., the second power supply cabinet 120 in FIG. 1) to request the upstream cabinet to adjust/compensate its output voltage and/or output current until the control unit of the terminal gun cabinet determines that the input voltage and/or input current of the terminal gun cabinet have reached the required target input voltage and/or target input current for the vehicle.

In one embodiment of the application, voltage compensation can be performed individually for each gun line. That is, if individual gun lines are charging respective different electric vehicles, the output voltage and output current of the gun lines can be individually compensated/controlled based on the charging requirements of each electric vehicle.

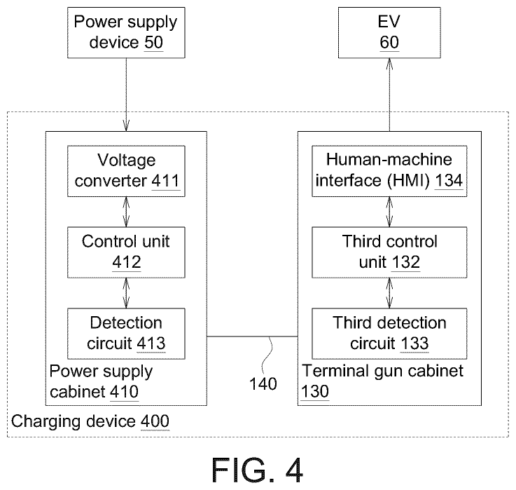

FIG. 4 shows a functional block diagram of a charging device according to another embodiment of the application. In one embodiment, the charging device 400 includes an (integrated) power supply cabinet 410, connection cables 140, and a terminal gun cabinet 130. The (integrated) power supply cabinet 410 is coupled to and communicates with the terminal gun cabinet 130 via connection cable 140. The (integrated) power supply cabinet 410 includes a voltage converter 411, a control unit 412, and a detection circuit 413. The control unit 412 is coupled to the voltage converter 411 and the detection circuit 413. The voltage converter 411 can perform AC-DC conversion and DC-DC conversion. Similarly, when the terminal gun cabinet 130 sends feedback indicating that the input voltage does not meet the target value, the control unit 412 controls the voltage converter 411 to adjust the output voltage until the input voltage of the terminal gun cabinet 130 meets the target value.

In FIG. 1, the first power supply cabinet 110 and the second power supply cabinet 120 are independent cabinets. However, in the embodiment of FIG. 4, the first power supply cabinet 110 and the second power supply cabinet 120 are integrated into a single integrated power supply cabinet 410. The operational principles of the integrated power supply cabinet 410 are essentially similar to those of FIG. 1, so the details are omitted here. Alternatively, whether using multiple independent cabinets or an integrated cabinet, they can be collectively referred to as a “power supply cabinet.”

The flowcharts in FIGS. 2 and 3 can be applied to the charging devices in FIGS. 1 and 4. In other words, the flowchart in FIG. 3 is a detailed version of the flowchart in FIG. 2.

In one embodiment of the application, the electric vehicle charging device is connected to the power supply device (e.g., the power supply device 50 in FIG. 1). The electric vehicle charging device includes a power supply cabinet (which may be a single integrated power supply cabinet or multiple independent power supply cabinets, as in FIG. 1) and a terminal gun cabinet. Each cabinet in the electric vehicle charging device has a control unit (e.g., but not limited to, a microcontroller) to control the operation of each cabinet. Additionally, each cabinet contains a detection circuit to monitor the voltage and current values during charging. Furthermore, the individual control units of these cabinets communicate with each other to compensate for voltage losses.

In one embodiment of the application, to ensure the accuracy of output voltage and current, the control unit of the downstream cabinet calculates the wire loss (i.e., the voltage difference between the target input voltage and the actual input voltage) and sends this information back to the control unit of the upstream cabinet. Here, the upstream cabinet refers to the cabinet closer to the power supply device, while the downstream cabinet refers to the cabinet farther from the power supply device. For example, considering cabinets 110 and 120, the cabinet 110 is the upstream cabinet, and the cabinet 120 is the downstream cabinet. Similarly, for cabinets 120 and 130, the cabinet 120 is the upstream cabinet, and the cabinet 130 is the downstream cabinet. This compensation mechanism ensures the accuracy of power delivery during electric vehicle charging. In other words, in this embodiment, the control unit of the downstream cabinet triggers the compensation process and progressively transmits it upstream to the control unit of the upstream cabinet. Here, the downstream cabinet is defined as the one closer to the vehicle in terms of charging current direction, while the upstream cabinet is defined as the one farther from the vehicle in terms of charging current direction.

The above description primarily presents the proposed solution from the perspective of an electric vehicle charging device. It is understood that, to achieve the described functionality, the electric vehicle charging device includes corresponding hardware structures and/or software modules that execute these functions. Professionals in the technical field should easily recognize that, based on the described embodiments and method steps, the application can be implemented in hardware form or as a combination of hardware and software, depending on the specific application and design constraints of the technical solution. Different methods may be used to implement each function for specific applications, but such implementations should not be considered beyond the scope of this application.

In one embodiment of the application, the electric vehicle charging device can be divided into multiple functional modules based on the previous descriptions. For example, it can be divided according to each corresponding function to obtain individual functional modules, or two or more functions can be integrated into a single integrated module. The integrated module can be implemented in hardware form or as a software functional module. It should be noted that in this application, the division into modules is merely an example and represents a logical functional division. Other division methods can be used in practical implementations. The following description is based on an example where each function is divided into a separate functional module.

Although the application describes many specific details, these should not be interpreted as limitations on the scope of the claimed invention but rather as descriptions of the characteristics of particular implementations. In this description, certain features described in the context of a single embodiment may also be implemented in combination within a single embodiment. Conversely, various features described in the context of a single embodiment may also be implemented separately or in any suitable subcombination across multiple embodiments. Furthermore, although certain features may initially be described as operating in certain combinations or even specified as such, in some cases, one or more features may be removed from the combination, and the described combination may still function as a subcombination or a variation thereof. Likewise, while the operations in the illustrations are depicted in a specific order, this should not be interpreted as requiring that these operations must be performed in the displayed order or sequence, or that all depicted operations must be executed to achieve the desired result.

Although the above embodiments of the application disclose only a few examples and implementations, modifications, alterations, and enhancements can be made to these disclosed examples and implementations, as well as to other possible implementations, based on the disclosed content.

What is claimed is:

1. A charging device for receiving an alternating current (AC) voltage from a power supply device and charging a vehicle, the charging device comprising:
a power supply cabinet, coupled to the power supply device, for converting the AC voltage received from the power supply device to obtain a power supply cabinet output voltage;
a first connection cable, coupled to the power supply cabinet; and
a terminal gun cabinet, coupled to the first connection cable, wherein the terminal gun cabinet is connected to and communicates with the power supply cabinet via the first connection cable, and the power supply cabinet supplies a terminal input voltage to the terminal gun cabinet through the first connection cable;
wherein,
a detection circuit of the terminal gun cabinet detects the terminal input voltage of the terminal gun cabinet;
based on a detection result of the terminal gun cabinet, a control unit of the terminal gun cabinet determines whether the terminal input voltage of the terminal gun cabinet has reached a terminal target value; and
based on a determination result of the terminal gun cabinet, the terminal gun cabinet decides whether to notify a control unit of the power supply cabinet to perform voltage compensation until the control unit of the terminal gun cabinet determines that the terminal input voltage of the terminal gun cabinet has reached the terminal target value.

2. The charging device according to claim 1, wherein the power supply cabinet comprises:
a first power supply cabinet and a second power supply cabinet, wherein the first power supply cabinet is coupled to the second power supply cabinet via a second connection cable.

3. The charging device according to claim 2, wherein:
the first power supply cabinet comprises:
a first voltage converter;
a first control unit, coupled to the first voltage converter; and
a first detection circuit, coupled to the first control unit, wherein the first control unit controls the first voltage converter,
the first voltage converter converts the AC voltage received from the power supply device into a first output voltage and transmits to the second power supply cabinet through the second connection cable,
the first detection circuit detects an input voltage and an input current flowing through the first power supply cabinet and transmits a detection result to the first control unit,
the first control unit communicates with the second power supply cabinet via the second connection cable; and
the second power supply cabinet comprises:
a second voltage converter;
a second control unit, coupled to the second voltage converter; and
a second detection circuit, coupled to the second control unit, wherein the second control unit controls the second voltage converter,
the second voltage converter converts the first output voltage received from the first voltage converter into a second output voltage and transmits to the terminal gun cabinet via the first connection cable,
the second detection circuit detects an input voltage and an input current flowing through the second power supply cabinet and transmits a detection result to the second control unit,
the second control unit communicates with the control unit of the terminal gun cabinet via the first connection cable.

4. The charging device according to claim 3, wherein when the detection result of the second detection circuit indicates that the input voltage received by the second power supply cabinet does not meet a required second power supply cabinet target value, the second control unit notifies the first control unit, and the first control unit controls the first voltage converter to adjust the first output voltage until the input voltage received by the second power supply cabinet meets the required second power supply cabinet target value.

5. The charging device according to claim 3, wherein the first voltage converter is an AC-DC voltage converter, and the second voltage converter is a DC-DC voltage converter.

6. The charging device according to claim 1, wherein
the power supply cabinet further comprises: a voltage converter, the control unit, and a detection circuit,
the control unit is coupled to the voltage converter and the detection circuit,
the voltage converter of the power supply cabinet performs AC-DC conversion and DC-DC conversion; and
in response that the control unit of the terminal gun cabinet returns an indication that the terminal input voltage does not meet the terminal target value, the control unit of the power supply cabinet controls the voltage converter of the power supply cabinet to adjust the power supply cabinet output voltage until the terminal input voltage of the terminal gun cabinet meets the terminal target value.

7. The charging device according to claim 1, wherein:
the control unit of the terminal gun cabinet communicates with the vehicle to determine a vehicle target input voltage required by the vehicle, and the terminal gun cabinet includes at least one gun cable;
the detection circuit of the terminal gun cabinet detects the terminal input voltage of the terminal gun cabinet;
the control unit of the terminal gun cabinet determines whether the terminal input voltage of the terminal gun cabinet has reached the vehicle target input voltage required by the vehicle;
in response to the determination by the control unit of the terminal gun cabinet that the terminal input voltage of the terminal gun cabinet has reached the vehicle target input voltage, the control unit of the terminal gun cabinet controls power supply to the at least one gun cable, enabling the at least one gun cable to charge the vehicle;
the control unit of the terminal gun cabinet continuously communicates with the vehicle to update the vehicle target input voltage required by the vehicle; and
in response to the determination by the control unit of the terminal gun cabinet that the terminal input voltage of the terminal gun cabinet has not reached the vehicle target input voltage, the control unit of the terminal gun cabinet communicates with the control unit of the power supply cabinet to request adjustment of the power supply cabinet output voltage until the control unit of the terminal gun cabinet determines that the terminal input voltage of the terminal gun cabinet has reached the vehicle target input voltage.

8. The charging device according to claim 1, wherein the terminal gun cabinet comprises multiple gun cables, and the gun cables individually charge multiple vehicles.

9. The charging device according to claim 8, wherein:
the control unit of the terminal gun cabinet individually compensates and controls the individual output voltage and individual output current of the gun cables based on the individual needs of the vehicles; and
the detection circuit of the terminal gun cabinet and/or a detection circuit of the power supply cabinet is used to monitor a detection result of voltage drop or current loss and to compensate a vehicle target input voltage and/or a vehicle target input current based on the detection result.

10. The charging device according to claim 1, wherein compensation for the terminal input voltage is initiated by the control unit of the terminal gun cabinet and is progressively transmitted to the control unit of the power supply cabinet.

11. A charging method for receiving an alternating current (AC) voltage from a power supply device and charging a vehicle, the charging method comprising:
converting the AC voltage received from the power supply device by a power supply cabinet to obtain a power supply cabinet output voltage;
supplying a terminal input voltage from the power supply cabinet to a terminal gun cabinet through a first connection cable, wherein the terminal gun cabinet is connected to and communicates with the power supply cabinet via the first connection cable;
detecting the terminal input voltage of the terminal gun cabinet by a detection circuit of the terminal gun cabinet;
based on a detection result of the terminal gun cabinet, determining, by a control unit of the terminal gun cabinet, whether the terminal input voltage of the terminal gun cabinet has reached a terminal target value; and
based on a determination result of the terminal gun cabinet, deciding whether the terminal gun cabinet should notify a control unit of the power supply cabinet to perform voltage compensation until the control unit of the terminal gun cabinet determines that the terminal input voltage of the terminal gun cabinet has reached the terminal target value.

12. The charging method according to claim 11, wherein the power supply cabinet comprises:
a first power supply cabinet and a second power supply cabinet, wherein the first power supply cabinet is coupled to the second power supply cabinet via a second connection cable.

13. The charging method according to claim 12, wherein:
the first power supply cabinet comprises:
a first voltage converter;
a first control unit, coupled to the first voltage converter; and
a first detection circuit, coupled to the first control unit, wherein the first control unit controls the first voltage converter,
the first voltage converter converts the AC voltage received from the power supply device into a first output voltage and transmits the converted AC voltage to the second power supply cabinet through the second connection cable,
the first detection circuit detects an input voltage and an input current flowing through the first power supply cabinet and transmits a detection result to the first control unit,
the first control unit communicates with the second power supply cabinet via the second connection cable; and
the second power supply cabinet comprises:
a second voltage converter;
a second control unit, coupled to the second voltage converter; and
a second detection circuit, coupled to the second control unit, wherein the second control unit controls the second voltage converter,
the second voltage converter converts the first output voltage received from the first voltage converter into a second output voltage and transmits to the terminal gun cabinet via the first connection cable,
the second detection circuit detects an input voltage and an input current flowing through the second power supply cabinet and transmits a detection result to the second control unit,
the second control unit communicates with the control unit of the terminal gun cabinet via the first connection cable.

14. The charging method according to claim 13, wherein when the detection result of the second detection circuit indicates that the input voltage received by the second power supply cabinet does not meet a required second power supply cabinet target value, the second control unit notifies the first control unit, and the first control unit controls the first voltage converter to adjust the first output voltage until the input voltage received by the second power supply cabinet meets the required second power supply cabinet target value.

15. The charging method according to claim 13, wherein the first voltage converter is an AC-DC voltage converter, and the second voltage converter is a DC-DC voltage converter.

16. The charging method according to claim 11, wherein
the power supply cabinet further comprises: a voltage converter, the control unit, and a detection circuit,
the control unit is coupled to the voltage converter and the detection circuit,
the voltage converter of the power supply cabinet performs AC-DC conversion and DC-DC conversion; and
in response that the control unit of the terminal gun cabinet returns an indication that the terminal input voltage does not meet the terminal target value, the control unit of the power supply cabinet controls the voltage converter of the power supply cabinet to adjust the power supply cabinet output voltage until the terminal input voltage of the terminal gun cabinet meets the terminal target value.

17. The charging method according to claim 11, wherein:
the control unit of the terminal gun cabinet communicates with the vehicle to determine a vehicle target input voltage required by the vehicle, and the terminal gun cabinet includes at least one gun cable;
the detection circuit of the terminal gun cabinet detects the terminal input voltage of the terminal gun cabinet;
the control unit of the terminal gun cabinet determines whether the terminal input voltage of the terminal gun cabinet has reached the vehicle target input voltage required by the vehicle;
in response to the determination by the control unit of the terminal gun cabinet that the terminal input voltage of the terminal gun cabinet has reached the vehicle target input voltage, the control unit of the terminal gun cabinet controls power supply to the at least one gun cable, enabling the at least one gun cable to charge the vehicle;
the control unit of the terminal gun cabinet continuously communicates with the vehicle to update the vehicle target input voltage required by the vehicle; and
in response to the determination by the control unit of the terminal gun cabinet that the terminal input voltage of the terminal gun cabinet has not reached the vehicle target input voltage, the control unit of the terminal gun cabinet communicates with the control unit of the power supply cabinet to request adjustment of the power supply cabinet output voltage until the control unit of the terminal gun cabinet determines that the terminal input voltage of the terminal gun cabinet has reached the vehicle target input voltage.

18. The charging method according to claim 11, wherein the terminal gun cabinet comprises multiple gun cables, and the gun cables individually charge multiple vehicles.

19. The charging method according to claim 18, wherein:
the control unit of the terminal gun cabinet individually compensates and controls the individual output voltage and individual output current of the gun cables based on the individual needs of the vehicles; and
the detection circuit of the terminal gun cabinet and/or a detection circuit of the power supply cabinet is used to monitor a detection result of voltage drop or current loss and to compensate a vehicle target input voltage and/or a vehicle target input current based on the detection result.

20. The charging method according to claim 11, wherein compensation for the terminal input voltage is initiated by the control unit of the terminal gun cabinet and is progressively transmitted to the control unit of the power supply cabinet.
